(19) United States
(12) Patent Application Publication
(10) Pub. No.: US 2026/0322882 A1
(43) Pub. Date: Oct. 15, 2026

(54) IN-VEHICLE IOT SUB-NETWORK ECOSYSTEM INCLUDING IOT CONTROLLERS DESIGNATED FOR COMMUNICATING WITH VEHICULAR AND NON-VEHICULAR IOT DEVICES

(71) Applicant: GM GLOBAL TECHNOLOGY OPERATIONS LLC, Detroit, MI (US)

(72) Inventors: Venkata Naga Siva Vikas VEMURI, Farmington Hills, MI (US); Ahmed F. AL ALAWY, Canton, MI (US); John SERGAKIS, Bloomfield Hills, MI (US); Azin NEISHABOORI, Plymouth, MI (US); Mustafa Hamada CHMEISEH, Shelby Township, MI (US)

(21) Appl. No.: 19/177,802

(22) Filed: Apr. 14, 2025

(51) Int. Cl. H04L 67/125; G07C 5/00; H04W 4/44

(52) U.S. Cl. CPC H04L 67/125; G07C 5/008; H04W 4/44

(57) ABSTRACT

An in-vehicle Internet of things (IoT) subnetwork is disclosed that includes: a first network access device (NAD) configured to communicate with and receive first requests from IoT devices and controllers external to a host vehicle; electronic control modules (ECMs) configured to control systems and devices within the host vehicle; and a second NAD isolating the first NAD from the ECMs and configured to receive second requests from the first NAD based on the first requests and allocate selected ones of the ECMs to perform operations to address the second requests.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to Internet of things (IoT) ecosystems.

A home (or residential) ecosystem is an interconnected network of smart devices and can include a central hub and multiple IoT devices that wirelessly communicate with the central hub. Examples of a home ecosystem are Amazon Alexa®, Apple HomeKit®, and Google Home®. The IoT devices can include smart speakers, appliances, smart electrical plugs, smart lights, smart switches, etc. A user is able to control the status of the IoT devices via the central hub or via an ecosystem application executed on, for example, a mobile phone.

### SUMMARY

An in-vehicle IoT subnetwork is disclosed that includes: a first network access device (NAD) configured to communicate with and receive first requests from IoT devices and controllers external to a host vehicle; electronic control modules (ECMs) configured to control systems and devices within the host vehicle; and a second NAD isolating the first NAD from the ECMs and configured to receive second requests from the first NAD based on the first requests and allocate selected ones of the ECMs to perform operations to address the second requests.

In other features, the second NAD is configured to communicate with a cloud-based network device to share vehicular information with the cloud-based network device. The cloud-based network device is a server of a manufacturer of the host vehicle, a roadside unit, a traffic or map server, or a weather server.

In other features, at least one of: i) the first NAD maintains a same root certificate for the IoT controllers that are external to the host vehicle, and ii) the first NAD and the second NAD share a same root certificate.

In other features, the IoT subnetwork further includes internal IoT controllers. The first NAD is configured to perform resource loading including prioritizing functions and to be performed and assign the functions to a selected one or more of the internal IoT controllers. The second NAD is implemented as one of the internal IoT controllers.

In other features, the second NAD is configured to perform resource loading and prioritize functions performed by the ECMs and assign selected ones of the ECMs to perform the functions.

In other features, the first NAD is configured to assign a same device type to the IoT controllers that are external to the host vehicle.

In other features, an interface between the first NAD and the second NAD is configured for transferring signals for concurrently handling at least one of i) requests from IoT devices and ii) controlling the IoT devices.

In other features, the first NAD is configured to: receive parameters and capability information from one of the IoT devices and controllers that are external to the host vehicle; update a matrix based on the parameters and capability information received; determine whether usage capacity of the first NAD is less than a minimum threshold; based on the capability information and in response to the usage capacity being greater than or equal to the minimum threshold, maintain status of the one of the IoT devices and controllers as active and monitor availability of multi-IoT controller interface between the first NAD and the second NAD based on the usage capacity; and based on the capability information and in response to the usage capacity being less than the minimum threshold, advertise intention of first NAD to lend and become a common rooted external IoT controller for multiple subnetworks.

In other features, the first NAD is configured to: determine classification of an IoT device or controller that is at least one of external to and separate from the host vehicle; in response to the classification being external or internal, determine whether to allocate resources to the IoT device or controller having the classification; and in response to the classification not being external or internal, update an entry in a matrix for the IoT device or controller indicating that the IoT device or controller is permitted to receive not transmit.

In other features, the first NAD is configured to: in response to determining to allocate resources to the IoT device or controller having the classification, run a prioritization matrix process and at least one of i) assign a resource load of the host vehicle to the IoT device or controller, and ii) assign a request for the IoT device or controller to the second NAD; and in response to determining not to allocate resources to the IoT device or controller having the classification, determine whether resources are needed for the IoT device or controller and in response to resources not being needed, mark in the matrix that the IoT device or controller as being in an idle state.

In other features, a method of operating an in-vehicle Internet of things (IoT) subnetwork is disclosed. The method includes: communicating with and receiving first requests at a first network access device (NAD) from IoT devices and controllers external to a host vehicle; controlling systems and devices within the host vehicle via electronic control modules (ECMs); isolating the first NAD from the ECMs via a second NAD; and receiving second requests at the second NAD from the first NAD based on the first requests; allocating via the second NAD selected ones of the ECMs to perform operations to address the second requests.

In other features, the method further includes via the second NAD communicating with a cloud-based network device to share vehicular information with the cloud-based network device. The cloud-based network device is a server of a manufacturer of the host vehicle, a roadside unit, a traffic or map server, or a weather server.

In other features, the method further includes at least one of: maintaining at the first NAD a same root certificate for the IoT controllers that are external to the host vehicle; and sharing a same root certificate by the first NAD and the second NAD.

In other features, the method further includes performing resource loading via the first NAD including prioritizing functions to be performed and assigning the functions to a selected one or more of internal IoT controllers of the host vehicle. The second NAD is implemented as one of the internal IoT controllers.

In other features, the method further includes, via the second NAD, performing resource loading and prioritizing functions performed by the ECMs and assigning selected ones of the ECMs to perform the functions.

In other features, the method further includes, via the first NAD, assigning a same device type to the IoT controllers that are external to the host vehicle.

In other features, the method further includes, via an interface between the first NAD and the second NAD, transferring signals for concurrently handling at least one of i) requests from IoT devices and ii) controlling the IoT devices.

In other features, the method further includes: receiving parameters and capability information at the first NAD from one of the IoT devices and controllers that are external to the host vehicle; updating a matrix based on the parameters and capability information received; determining whether usage capacity of the first NAD is less than a minimum threshold; based on the capability information and in response to the usage capacity being greater than or equal to the minimum threshold, maintaining status of the one of the IoT devices and controllers as active and monitoring availability of multi-IoT controller interface between the first NAD and the second NAD based on the usage capacity; and based on the capability information and in response to the usage capacity being less than the minimum threshold, advertising intention of first NAD to lend and become a common rooted external IoT controller for multiple subnetworks.

In other features, the method further includes: determine, via the first NAD, classification of an IoT device or controller that is at least one of external to and separate from the host vehicle; in response to the classification being external or internal, determine whether to allocate resources to the IoT device or controller having the classification; and in response to the classification not being external or internal, update an entry in a matrix for the IoT device or controller indicating that the IoT device or controller is permitted to receive not transmit.

In other features, an in-vehicle IoT subnetwork is disclosed and includes: a first IoT controller implemented in a host vehicle and configured to communicate with and receive first requests from IoT devices and controllers external to the host vehicle; ECMs configured to control systems and devices within the host vehicle; and a second IoT controller implemented in the host vehicle and isolating the first IoT controller from the ECMs and configured to receive second requests from the first IoT controller based on the first requests and allocate selected ones of the ECMs to perform operations to address the second requests.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example IoT ecosystem including a vehicle including an in-vehicle IoT subnetwork ecosystem in accordance with the present disclosure;

FIG. 2 is a functional block diagram of an example vehicle including an example in-vehicle IoT subnetwork ecosystem including network access devices (NADs) implemented as an external (or non-vehicular) IoT controller and an internal (or vehicular IoT controller) in accordance with the present disclosure;

FIG. 3 is a functional block diagram of an example vehicle including an example in-vehicle IoT subnetwork ecosystem including a single NAD including a virtual external (or non-vehicular) IoT controller and a virtual internal (or vehicular IoT controller) in accordance with the present disclosure;

FIG. 4 is a functional block diagram of an example vehicle including an in-vehicle IoT subnetwork ecosystem and other systems in accordance with the present disclosure;

FIG. 5 illustrates a commissioning method implemented by an external (or non-vehicular) IoT controller in accordance with the present disclosure;

FIG. 6 is a functional block diagram illustrate a portion of an IoT ecosystem including a portion of an in-vehicle IoT subnetwork ecosystem and some example corresponding fabrics in accordance with the present disclosure; and

FIG. 7 illustrates a security method implemented by an external (or non-vehicular) IoT controller including determine whether to treat an external IoT device as an internal IoT device in accordance with the present disclosure.

In the drawings, reference numbers may be reused to identify similar and/or identical elements.

### DETAILED DESCRIPTION

A vehicle can be part of a home IoT ecosystem (or smart home ecosystem) and/or other IoT ecosystem (e.g., an IoT ecosystem at a place of business, an airport, etc.). A vehicle can play a vital role in a connected home experience and can be one of the most frequently used smart devices in individuals’ daily lives. Features that require a vehicle to be connected can be utilized by both home IoT devices and a vehicle. As a few examples, the features can include an individual’s calendar of scheduled events, emergency calling and tracking features, security monitoring and alerting features, etc. The home IoT devices and the vehicle benefit from the vehicle being connected to share feature information and/or to perform feature related functions.

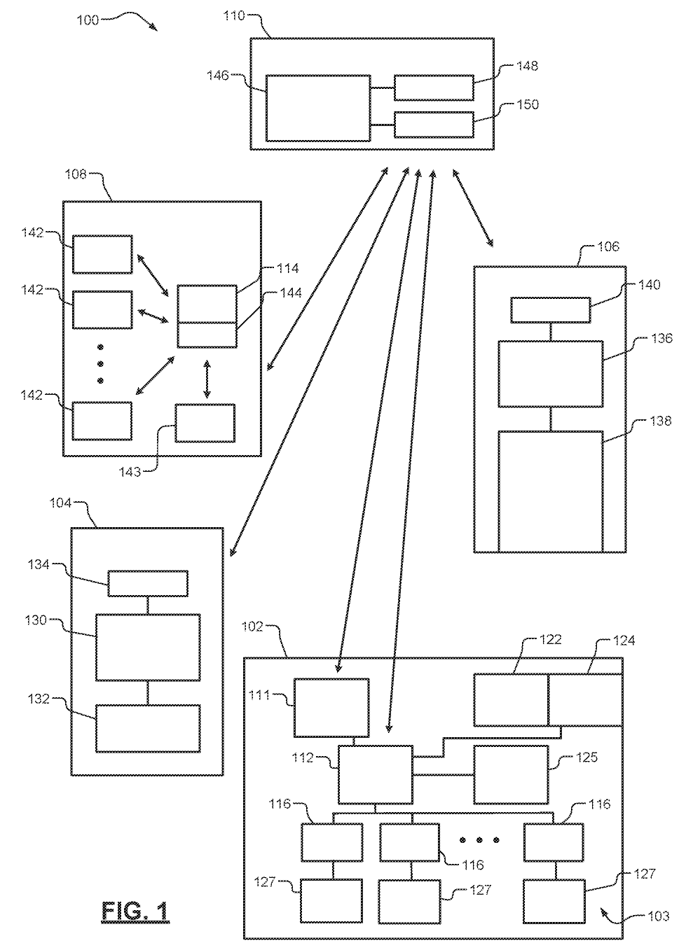

As used herein, the term “feature” may refer to a device, component and/or technology element that contributes to vehicle functionality, vehicle safety, and/or user experiences with the vehicle. A function may refer to operational and performance capabilities of a given feature that the vehicle implements for the user. As used herein, an attribute may refer to a parameter used by, calculated by, and/or output from a particular function. An example of a feature is an emergency call made by the vehicle to a cloud-based server due to a collision that occurred with the vehicle. This feature is implemented by multiple ECMs of the vehicle. The ECMs function to collect data and then make a call to the cloud-based server to upload the data. As another example, a feature may refer to a security monitoring mode while the vehicle is in the OFF state. A vehicle may perform many features that require connectivity between the vehicle and an external IoT ecosystem such as: checking a vehicle charge status; remotely communicating with the vehicle to turn ON; starting a heater in the vehicle or in the external IoT ecosystem; locking a door of the vehicle or in the external IoT ecosystem; closing a window of the vehicle or in the external IoT ecosystem; turning ON or OFF lights of the vehicle or in the external IoT ecosystem; charging a power source of the vehicle; etc. These features may be triggered by for example, a central hub (example of which shown in FIG. 1), a portable access device, the vehicle, a charging station, or other device.

In order for IoT devices manufactured by different manufacturers to communicate with a same central hub and/or to be controlled with a same single application executed on a single mobile device, the IoT devices and the central hub may be configured to communicate with each other using a Matter® protocol developed by the Connectivity Standards Alliance (CSA).

Traditionally, each IoT device in a Matter® ecosystem has a unique feature as a device type. A vehicle is different than a traditional IoT device in that the vehicle can have multiple IoT devices implementing respective features.

The examples set forth herein include in-vehicle IoT subnetwork ecosystems that can be part of an overall IoT ecosystem, which includes IoT devices external, separate and/or remote from a host vehicle. The in-vehicle IoT subnetwork ecosystems are multi-device subnetworks implementing features within the vehicle. The examples include a dual NAD interface between i) external IoT devices and/or external IoT controllers and ii) vehicle internal electronic control modules (ECMs). This provides added security and multi-level separation between IoT devices and controllers external to a host vehicle and ECMs internal to the vehicle, which prevents possible exposure of ECM functions to external IoT devices and controllers.

The examples set forth herein include multi-fabric single root certificate IoT management, where a single root certificate is used when an external IoT device and/or controller is communicating with a host vehicle. The single root certificate is used by the external IoT device and/or controller and validated by an external (non-vehicular) NAD within the vehicle. The non-vehicular NAD refers to a NAD within the vehicle communicating with IoT devices external to the vehicle, whereas a vehicular NAD refers to a NAD that separates the external (non-vehicular) NAD from ECMs and communicates with the ECMs. The ECMs control in-vehicle systems and devices.

In an embodiment, the external IoT device and/or controller is accepted by the external (non-vehicular) NAD, which may operate according to Matter® protocols as part of the vehicle subnetwork ecosystem. The external (non-vehicular) NAD determines device classification based on information received from the external IoT device and/or controller such as capabilities, energy usage, availability time, expected time in the ecosystem, etc. A classification determination may then be made by the external (non-vehicular) NAD as to whether the external IoT device and/or controller is already classified as an internal (or in-subnetwork device) or as an external device. If already classified as is an internal or as an external device, then a flag is set equal to True. Otherwise, if not already classified, then a classification determination may be made. When True, the external IoT device and/or controller may be assigned to a specific NAD in a multi-NAD multi-instance vehicle architecture. If False, then the external (non-vehicular) NAD updates information regarding the external IoT device and/or controller in a stored matrix (or table) as being a device for receiving signals from the vehicle only, as opposed to a device from which signals may be received and acted upon by the vehicle. The external (non-vehicular) NAD may then run a prioritization process and assign resource load for each internal device fabric associated with a received request from the external IoT device and/or controller. In an embodiment, the external (non-vehicular) NAD instructs the internal (vehicular) NAD to run the prioritization process and assign a resource load for each of the internal device fabrics.

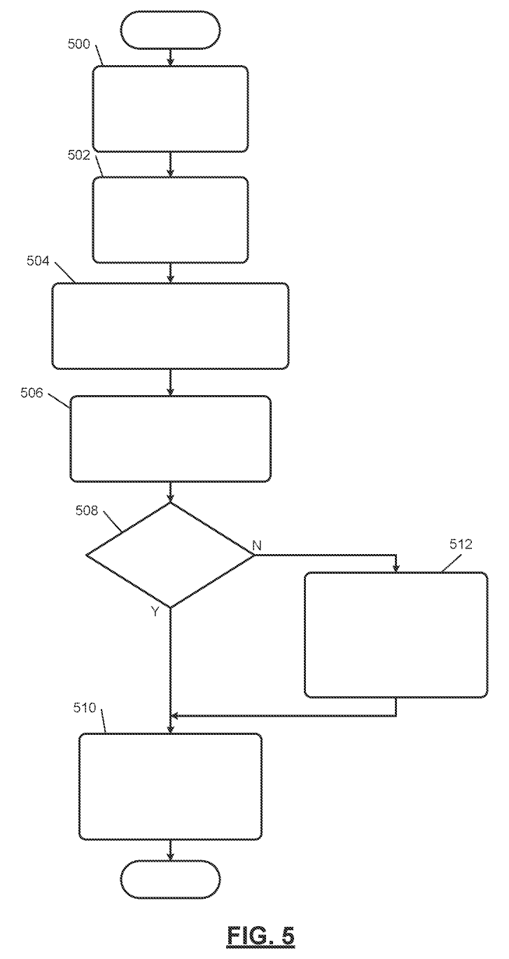

In another embodiment, in-vehicle multi-IoT controller resource management is implemented. Each IoT and/or Matter® compatible device advertises intention to join an IoT and/or Matter® network. The external (non-vehicular) NAD or internal (vehicular) NAD, which may each be referred to as a Matter® controller, requests device parameters of the IoT device requesting to join the network. The external (non-vehicular) NAD or internal (vehicular) NAD categorizes and assigns the IoT device to one internal (vehicular) controller that is chosen based on security requirements, capacity states and/or capabilities, etc. At every given instance in time, the Matter® controllers would have a matrix of their individual subnetworks. If controller capacity usage of one of the Matter® controllers is less than a minimum threshold, then that Matter® controller advertises intention to lend and become a common rooted Master® controller for multiple subnetworks. This is because that Matter® controller is controlling operations of IoT devices in multiple subnetworks. If not, the Matter® controller keeps a current Matter® status active and dynamically monitors availability of the multi-IoT controller interface, which includes the Matter controllers, if the minimum threshold is met. This is further described with respect to FIG. 5.

The examples disclosed herein are applicable to applications when vehicle passengers bring their own devices, such as mobile phones, tablets, and gaming consoles. As an example, a host vehicle may be a member of a ridesharing fleet, be mobile, and be occupied by five passengers. The host vehicle has its own internal IoT process to perform such as route optimization, determine resource management and allocation, etc., The vehicle can leverage the internal (vehicular) NAD (or internal IoT controller) to do vehicle centric applications and leverage the external (non-vehicular) NAD (or external IoT controller) to open an application programming interface (API) for the five passengers who are leveraging vehicle IoT resources for bring your own device (BYOD) type applications such as gaming console applications, tablet viewing applications, etc.

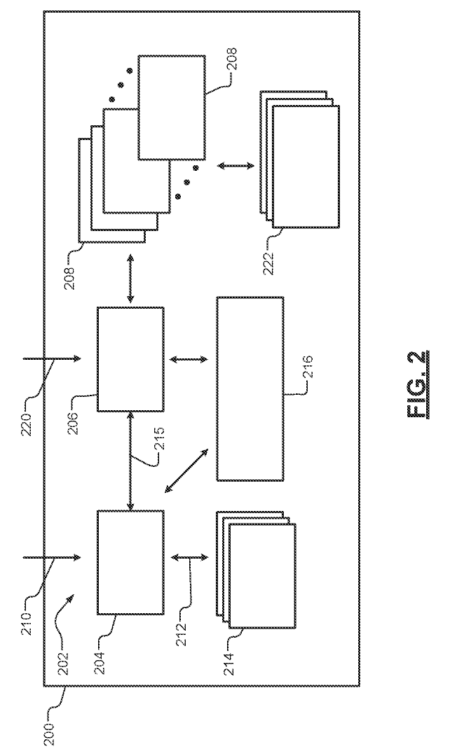

FIG. 1 shows an example IoT ecosystem 100 including a vehicle 102 including an in-vehicle IoT subnetwork ecosystem 103. The IoT ecosystem 100 may further includes a portable access device 104, a charging station 106, a building 108, and a cloud-based server 110. Other examples of vehicles that may be included in the IoT ecosystem are shown in FIGS. 2-4 and 6.

The vehicle 102 includes a first NAD 111, a second NAD 112, ECMs 116, power sources 122, and a charging system 124. Each of the NADs 111, 112 may establish a Wi-Fi® connection and be implemented as an IoT controller. The first NAD 111 may communicate with IoT devices and controllers separate from the vehicle 102, such as those in the portable access device 104, the charging station 106 and the building 108 via, for example, the cloud-based server 110 and/or via one or more other cloud-based servers and/or via a distributed network.

The second NAD 112 may communication with the first NAD 111, the ECMs 116, the charging system 124, and other devices 125. Although a single NAD is shown between the first NAD 111 and the ECMs 116, additional NADs may be included. The second NAD 112 may communicate with the cloud-based server 110. In an embodiment, the cloud-based server 110 is a server of a manufacturer of the vehicle 102. The second NAD 112 does not communicate with the portable access device 104, the charging station 106 and the building 108 and is isolated from the portable access device 104, the charging station 106 and the building 108 by the first NAD 111. The communication between the NAD 112 and the cloud-based server 110 may include the downloading of control information, the uploading and/or downloading of traffic information, downloading of manufacturer specific information, downloading of activation rules for activating the ECMs 116 and/or corresponding devices 127 controlled by the ECMs 116, sharing of cellular data, sharing of roadside unit data and/or information, etc. In an embodiment, the cloud-based server is a server of a manufacturer of the vehicle, a roadside unit, a traffic or map server, or a weather server.

The stated communication between the first NAD 111 and the portable access device 104, the charging station 106, the building 108, and the cloud-based server 110 may include transmission and reception of radio frequency (RF) signals, Wi-Fi™ signals, local area network (LAN) signals, Thread signals, Bluetooth® signals, Bluetooth®, Bluetooth Low Energy (BLE) signals, Ultra-Wideband (UWB) signals, etc. The use of Wi-Fi™ signals minimizes communication times between the first NAD 111 and the portable access device 104, the charging station 106 and/or the building 108, which reduces power consumption associated with this communication. The Wi-Fi™ communication is quicker and cheaper than, for example, cellular communication. The stated communication allows the vehicle 102 to perform more operations while OFF and in a connectivity mode. When in the connectivity mode, one or more communication links have been established between i) one or more ECMs, telematics module, and/or an IoT controller of the vehicle and ii) a cloud-based server of a back office. The back office may be a back office of a service provider (e.g., a manufacturer of the vehicle). The back office may also be in communication with a central hub and/or IoT controller of a building IoT ecosystem such as a home or office IoT ecosystem an airport IoT ecosystem, or other facility IoT ecosystem.

The portable access device 104 may be a mobile phone, a tablet, a wearable device (e.g., a smart watch), a key fob, etc. and includes a control module 130, a memory 132, and a transceiver 134. The charging station 106 includes a charge control module 136, a charger 138, and a transceiver 140. The building 108 includes the central hub 114, IoT devices 142, a modem 143 (e.g., a wireless fidelity (Wi-Fi™) modem), and a transceiver 144. The building 108 may be a residential home, a commercial building, or other building. The cloud-based server 110 includes a server control module 146, memory 148 and a transceiver 150.

The charging station 106 (or vehicle charger) may be installed in the building 108, on a wall of the building 108, or be a separate charging station proximate to the building 108. The central hub 114 may be a home (or residential) hub, a commercial building hub, or other central hub with a corresponding ecosystem including IoT devices 142. The IoT devices 142 may include speakers, Wi-Fi™ compatible devices, appliances (e.g., refrigerators, washers, dryers, ovens, etc.), lights, light bulbs, plugs, switches, buttons, etc. An IoT device refers to a device that can connect to the Internet and share data.

The IoT ecosystem 100 may implement protocols of home ecosystems such as protocols of an Amazon Alexa® ecosystem, an Apple HomeKit® ecosystem, and/or a Google Home® ecosystem. The central hub 114 and the IoT devices 142 may be configured to operate and communicate according to one of these ecosystems. The central hub 114 may be in communication with a cloud-based server associated with one of these ecosystems.

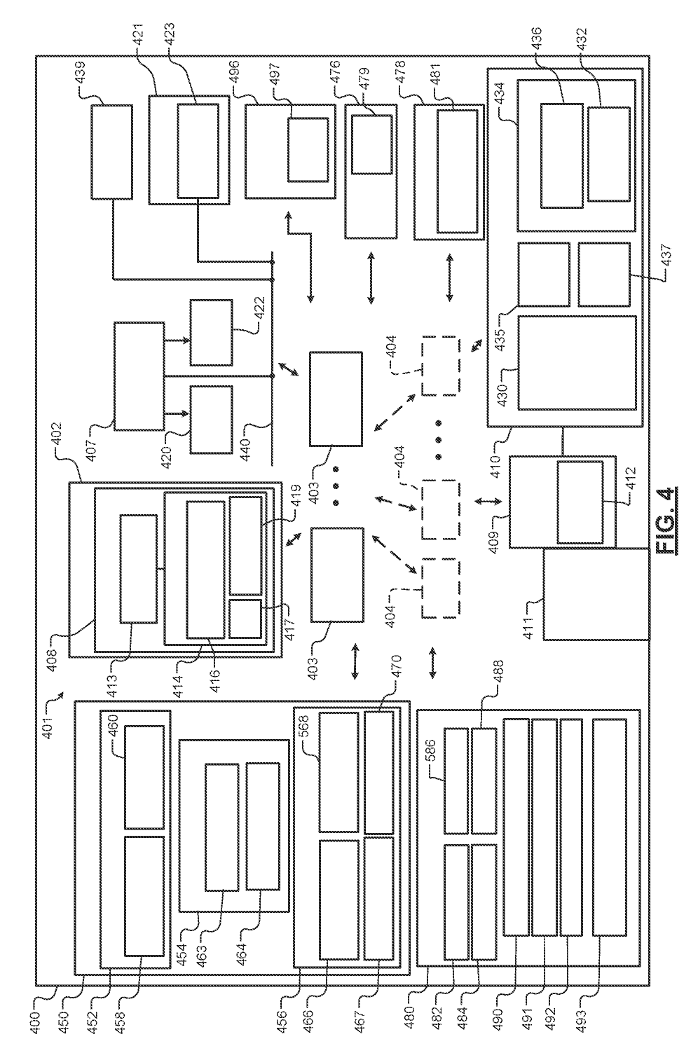

The NADs 111, 112 may operate respectively as any of the external (non-vehicular) NADs (or external IoT controllers) and internal (vehicular) NADs (or internal IoT controllers) referred to herein. In an embodiment, the first NAD 111 includes a telematics module, as shown in FIG. 4. In an embodiment, the second NAD 112 controls and allocates ECM resources for requests received from the NAD 111. The ECMs 116 may control various vehicle systems such as a braking system, a steering system, an infotainment system, a lighting system, etc. The vehicle 102 may have up to 50-100 ECMs. The NADs 111, 112 may share multi-NAD interface logic such as functionality and capacity information such as functions to be performed, whether one or more ECMs are available to perform requested functions, timing of when functions are to be performed, power to perform each of the functions, etc.

The vehicle 102 may connect to the central hub 114 to perform tasks for or with the IoT devices 142. This may include the first NAD 111 communicating with the central hub 114. The central hub 114 may connect to the first NAD 111 to perform tasks for or with the second NAD 112 and/or the ECMs 116.

FIG. 2 shows a vehicle 200 that includes an example in-vehicle IoT subnetwork ecosystem 202 including network access devices (NADs) 204, 206 implemented respectively as an external (or non-vehicular) IoT controller and an internal (or vehicular IoT controller), and ECMs 208. The first NAD 204 may receive an external device commissioning logic request 210. The commissioning logic request 210 may be received from an IoT device and/or controller (e.g., a portable IoT device such as a smart phone or tablet, a building IoT hub, etc.) separate from the vehicle and requesting to communicate with, to collect information from, and/or for the vehicle to perform one or more operations and/or functions associated with a feature. The first NAD 204 may also receive requests 212 from IoT capable BYODs or other external (non-vehicular) devices 214. The IoT capable BYODs or other external (non-vehicular) devices 214 may be physically located outside or inside the vehicle 200. The first NAD 204 isolates the second NAD 206 from devices external to the vehicle 200 and providing, for example, the signals 210, 212. This protection is provided when the vehicle 200 is stationary or mobile and prevents external devices from being able to access data and/or devices of the vehicle 200, such as sensors and/or cameras of the vehicle 200.

The first NAD 204 handle non-vehicle centric tasks and the second NAD 206 handles vehicle centric tasks. The first NAD 204 determines which tasks are to be performed. The second NAD 206 determines which devices (e.g., ECMs 208) are to perform the tasks. In an embodiment, each of the NADs 204, 206 is implemented as a respective chipset. In another embodiment, each of the NADs 204, 206 is implemented as a single chip.

Multi-interface logic may be transferred between the NADs 204, 206 via an interface 215 between the NADs 204, 206. The interface 215 may be used for transferring logic associated with different functions that are to be performed by different devices. The functional capacity and availability of this interface 215 may be monitored by the first NAD 204, as further described below.

The NADs 204, 206 may access respective allocated portions of a partitioned memory 216. In an embodiment, the NAD 206 is configured to access all of the memory 216, whereas the NAD 204 is configured to only access an allocated portion of the memory 216.

The second NAD 206 may receive requests from the first NAD 204 based on the requests received at the first NAD 204 and perform resource loading. The second NAD 206 is configured to perform resource loading and prioritize functions performed by the ECMs 208 and assign selected ones of the ECMs 208 to perform the functions. The NAD 206 may perform load balancing by determining which of the one or more ECMs 208 to be allocated to perform each of one or more requested functions and/or operations, which may be requested by the NAD 204 due to requests received in, for example, signals 210, 212.

The NAD 206 may receive a multi-logic request and/or information from a back office. Signal 220 represents the multi-logic request and/or information. This may include the downloading of control information to the NAD 206, the uploading and/or downloading of traffic information between the back office and the NAD 206, downloading of manufacturer specific information to the NAD 206, downloading of activation rules for activating the ECMs 208 and/or corresponding vehicle systems and/or devices 222 controlled by the ECMs 208, sharing of cellular data, sharing of roadside unit data and/or information, etc. The vehicle systems and/or devices 222 may include, for example: aggregators; cameras; sensors; ambient lighting devices; media devices; casting devices; chargers; braking, steering and/or propulsion systems and devices; etc.

The NADs 204, 206 may share functionality and capacity information such as functions to be performed by the ECMs 208, whether one or more ECMs 208 are available to perform requested functions, timing of when functions are to be performed, power to perform each of the functions, etc. When there is more than one internal IoT controller, the availability of each of the internal IoT controllers and associated functions capable of being performed by the internal IoT controllers may also be shared.

The NADs 204, 206 are part of the same vehicle subnetwork ecosystem and thus can share a common root certificate, which may be used to communicate with each other and/or with other IoT devices within the vehicle subnetwork ecosystem. This allows for quick authentication without negotiating for a new root certificate. This also allows for a process of commissioning to only be performed once and thereafter commissioning is no longer needed when the NADs 204, 206 communicate with each other and/or with other IoT devices and/or controllers in the same vehicle subnetwork ecosystem.

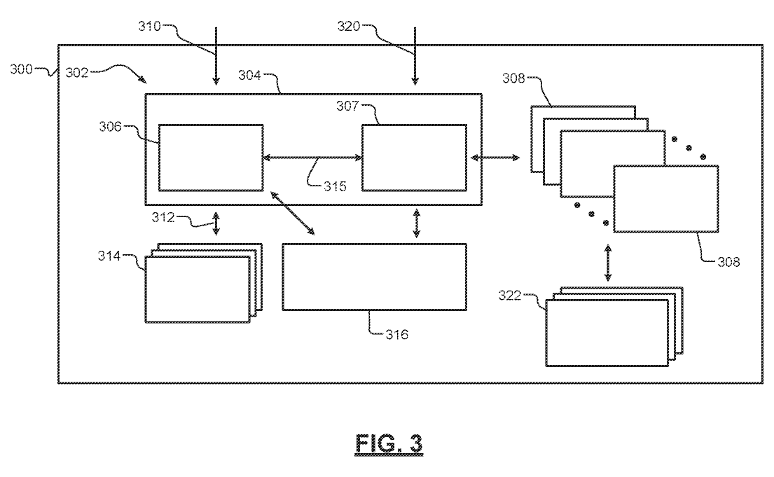

FIG. 3 shows an example vehicle 300 including an example in-vehicle IoT subnetwork ecosystem 302 including i) a single NAD 304 including a virtual external (or non-vehicular) IoT controller 306 and a virtual internal (or vehicular IoT controller) 307, and ii) ECMs 308. The virtual external IoT controller 306 may receive an external device commissioning logic request 310. The commissioning logic request 310 may be received from an IoT device and/or controller separate from the vehicle and requesting to communicate with, collect information from, and/or for the vehicle to perform one or more operations and/or functions associated with a feature. The virtual external IoT controller 306 may also receive requests 312 from IoT capable BYODs or other external (non-vehicular) devices 314. The IoT capable BYODs or other external (non-vehicular) devices 314 may be physically located outside or inside the vehicle 300. The first virtual IoT controller 306 isolates the second virtual IoT controller 307 from devices external to the vehicle 300 and providing, for example, the signals 310, 312. This protection is provided when the vehicle 300 is stationary or mobile and prevents external devices from being able to access data and/or devices of the vehicle 300, such as sensors and/or cameras of the vehicle 300. The virtual IoT controller 306 handle non-vehicle centric tasks and the virtual IoT controller 307 handles vehicle centric tasks.

The first virtual IoT controller 306 handle non-vehicle centric tasks and the second virtual IoT controller 307 handles vehicle centric tasks. The first virtual IoT controller 306 determines which tasks are to be performed. The second virtual IoT controller 307 determines which devices (e.g., ECMs 308) are to perform the tasks.

Multi-interface logic may be transferred between the virtual IoT controllers 306, 307 via an interface 315 between the virtual IoT controllers 306, 307. The interface 315 may be used for transferring logic associated with different functions that are to be performed by different devices. The functional capacity and availability of this interface 315 may be monitored by the first virtual IoT controller 306, as further described below.

The virtual IoT controller 306, 307 may access respective allocated portions of a partitioned memory 316. In an embodiment, the virtual internal IoT controller 307 is configured to access all of the memory 316, whereas the virtual external IoT controller 306 is configured to only access an allocated portion of the memory 316.

The virtual internal IoT controller 307 may receive a multi-logic request and/or information from a back office. Signal 320 represents the multi-logic request and/or information. This may include the downloading of control information to the virtual internal IoT controller 307, the uploading and/or downloading of traffic information between the back office and the NAD 206, downloading of manufacturer specific information to the virtual internal IoT controller 307, downloading of activation rules for activating the ECMs 308 and/or corresponding vehicle systems and/or devices 322 controlled by the ECMs 308, sharing of cellular data, sharing of roadside unit data and/or information, etc.

The virtual IoT controllers 306, 307 may share functionality and capacity information such as functions to be performed by the ECMs 308, whether one or more ECMs 308 are available to perform requested functions, timing of when functions are to be performed, power to perform each of the functions, etc. When there is more than one internal IoT controller, the availability of each of the internal IoT controllers and associated functions capable of being performed by the internal IoT controllers may also be shared.

The virtual IoT controllers 306, 307 are part of the same vehicle subnetwork ecosystem and thus can share a common root certificate, which may be used to communicate with each other and/or with other IoT devices within the vehicle subnetwork ecosystem. This allows for quick authentication without negotiating for a new root certificate. This also allows for a process of commissioning to only be performed once and thereafter commissioning is no longer needed when the virtual IoT controllers 306, 307 communicate with each other and/or with other IoT devices and/or controllers in the same vehicle subnetwork ecosystem.

FIG. 4 shows a host vehicle 400 that includes an in-vehicle IoT subnetwork ecosystem 401, which may include a first NAD 402 (or external IoT controller), one or more other NADs 403 and multiple ECMs 404. Although shown as separate ECMs, the ECMs 404 may be implemented as part of the systems of the host vehicle 400, such as part of any of the systems referred to below. The NADs 402, 403 may operate the same or similarly as any of the NADs referred to herein.

The host vehicle 400 may represent any of the vehicles 102, 200, 300 of FIGS. 1-3. The vehicle 400 includes an infotainment module 407. The NAD 402 may include a telematics module 408. The infotainment module 407 and the telematics modules 408 may each be implemented as one of the ECMs 404. The ECMs 404 may be implemented as an access module, a vehicle control module, a brake control module, a steering control module, etc. The host vehicle 400 may be a partially or fully autonomous vehicle, a vehicle with assisted driving capabilities, or a non-autonomous vehicle.

The host vehicle 400 further includes one or more power sources 409 and a propulsion system 410. The vehicle control module may control operation of the host vehicle 400 including the propulsion system 410 and other system described below. The power sources 409 may include one or more batteries and/or battery packs, a generator, a converter, a control circuit, terminals for high and low voltage loads, etc., as well as one or more battery sensors 412 for detecting states of the power sources 509 including voltages, current levels, states of charge, etc. A charging system 411 may be included for charging the power sources 409. The charging system 411 may be plugged into a building charging station and/or charger, as referred to herein.

The telematics module 408 provides wireless communication services within the host vehicle 400 and wirelessly communicates with access secured devices, service providers, network devices (e.g., cloud-based network devices, central office devices, and/or back-office devices), other vehicles, mobile devices, infrastructure devices, and other devices external and/or internal to the host vehicle 400. The telematics module 408 may support Wi-Fi®, Bluetooth®, BLE, UWB, near-field communication (NFC), cellular, legacy (LG) transmission control protocol (TCP), long-term evolution (LTE), and/or other wireless communication and/or operate according to Wi-Fi®, Bluetooth®, BLE, UWB, NFC, cellular, and/or other wireless communication protocols. The telematics module 408 may include one or more transceivers 413 and a navigation module 414 with a global positioning system (GPS) and GNSS (or Global Navigation Satellite System) receiver 416. The navigation module 414 may include an inertial measurement unit (IMU) 417 and an odometer/wheel sensor 419. The transceivers 413 wirelessly communicate with network devices internal and external to the host vehicle 402 including cloud-based network devices, central stations, back-offices, and portable network devices. The transceivers 413 may perform pattern recognition, channel addressing, channel access control, and filtering operations.

The navigation module 414 executes a navigation application to provide navigation services. The navigation services may include location identification services to identify where the host vehicle 400 is located. The navigation services may also include guiding a driver and/or directing the host vehicle 400 to a selected location. The navigation module 414 may communicate with a central station to collect map information indicating levels of traffic, transportation object identification and locations (e.g., locations and types of signs), path information, weather information, etc. As an example, if the host vehicle 400 is an assisted and/or automated driving vehicle, the navigation module 414 may direct the vehicle control module 406 along a selected route to a selected destination. The GPS and GNSS receiver 416 may provide: location information; velocity and/or direction (or heading) of the host vehicle 400, other vehicles, and objects (e.g., pedestrians and cyclists); and/or global clock timing information.

One or more HUDs (also referred to as augmented reality (AR) HUDs) 421 are included and may include one or more HUD control module(s) (one HUD control module 423 is shown). The HUD control module 423 is in communication with the modules 406 and may display information regarding devices within a building and ecosystem such as states of access secured devices and IoT devices. This may include states of these devices (e.g., open, closed, locked, unlocked, on, off, etc.)

The infotainment module 407 may include and/or be connected to an audio system 422 and/or a video system including one or more displays. The displays 420, 421 and audio system 422 may be part of a human machine interface. The displays 420, 421 may include cluster and/or center console displays, etc. Haptic devices (e.g., steering wheel and/or seat vibration devices) may be used in addition to the displays 420, 421 and the audio system 422 to interact with a vehicle occupant such as a driver or passenger. This interaction is further described below. Messages may be displayed, audibly played out, and/or indicated via the displays 420, 421, the audio system 422, the haptic devices, and/or via one or more other output devices.

The infotainment module 407 may provide various information, the above-stated device information, warnings, and proactive messages including: status information; routing information; whether driving operations are autonomously controlled, limited and/or prevented; gear shifter status; upcoming and currently being performed operations (e.g., braking, accelerating, turning operations); detected objects (or obstacles); vehicle status information; diagnostic information; prognostic information; entertainment features and information; etc. The infotainment module 407 may be used to guide a vehicle operator to a certain location, indicate trip estimations (e.g., distances to selected destinations), and other information.

The propulsion system 410 may include one or more torque sources, such as one or more motors and/or one or more engines (e.g., internal combustion engines). In the example shown in FIG. 1, the host vehicle 400 includes an engine 430 and one or more motors 432. The torque sources are independently controlled. The propulsion system 410 includes a motor control system 434 that includes the one or more motors 432 and a motor control module 436 that may control operation of the one or more motors 432 based on signals from the vehicle control module. The propulsion system 410 may include a gear selector and/or shifter 435 for setting a gear of a transmission 437 and/or for setting a drive state of one or more of the torque sources. The gear selector and/or shifter 435 may be an electronic selector (e.g., one or more electrical switches), a mechanical and/or electrical shifter, or other selector and/or shifter. The propulsion system 410 may be controlled based on position of an accelerator 439 (e.g., an accelerator pedal, a throttle plate, etc.).

The ECMs 404 and modules 407, 408, 423 may communicate with each other directly or indirectly via one or more buses 440, such as a controller area network (CAN) bus and/or other suitable interface. The vehicle control module may control operation of vehicle modules, devices and systems based on feedback from sensors 450 and information and/or instructions received from a cloud-based network device.

The sensors 450 may include exterior sensors 452, interior sensors 454, and other sensors 456. The exterior sensors 452 may include radar and/or lidar sensors 458 and imaging and audio devices (e.g., visual spectrum cameras, long-wave infrared cameras, short-wave infrared cameras, ambient light sensors, and microphone or microphone array) 460. The exterior sensors 452 may be used to detect objects external to the host vehicle 400 and/or in a path of the host vehicle 400. The objects may include lane markings and objects, other vehicles, pedestrians, bicyclists, etc. The exterior sensors 452 may include sensors for determining location and/or range of the vehicle 400 relative to an object and/or device.

The interior sensors 454 may include one or more interior imaging sensors (e.g., cameras) 463, and a microphone or microphone array 464. The interior sensors 454 may be part of a driver monitoring system (DMS). The cameras 463 may be used to detect, track and/or monitor vehicle occupants including detecting locations of vehicle occupants in the vehicle, anatomical features (e.g., face, arms, hands, legs, etc.) of the vehicle occupants, head locations and/or eyes, etc. The interior sensors 454 may be used to detect gaze directions of a driver and/or vehicle occupants. The interior sensors 454 may include door sensors, seat belt sensors, seat sensors, etc. The door sensor may indicate whether a door is open or closed. The seat belt sensors may indicate whether seat belts are buckled. The seat sensor may include, for example, load sensors, strain gauges, and/or piezoresistive or piezoelectric sensors for detecting whether an occupant is in a particular seat and the weight of the occupant.

The other sensors 456 may include a gear selector and/or shifter sensor 467, a vehicle speed sensor 466, acceleration sensors (e.g., longitudinal and lateral acceleration sensors) 468, and a fuel level sensor 470, as shown, and other sensors. Additional sensors may also be included such as brake system sensors (a brake sensor 479 is shown) and steering system sensors (a steering angle sensor 481 is shown). The gear selector and/or shifter sensor 467 generates a signal indicative of a state of the gear selector and/or shifter 435.

The vehicle control module may also include a mode selection module and a parameter adjustment module. The parameter adjustment module may be used to adjust parameters of the host vehicle 400. The vehicle control module may perform autonomous operations based on interaction with a vehicle occupant. As an example, the vehicle control module may operate in a fully or partially autonomous mode and may control the propulsion system 410, a brake system 476, and a steering system 478. In an embodiment, the vehicle control module controls operation of the systems 410, 476 and 478 based on or without interactions with a vehicle occupant. The vehicle control module may i) perform autonomous operations such as steering, braking, accelerating, etc., and/or ii) display and/or audibly playout messages, perform haptic operations via haptic devices, and/or output messages and/or corresponding signals via other output devices.

The host vehicle 400 may further include the memory 480. The memory 480 may store sensor data 482, parameters 484, applications 486, algorithms 488, historical data 490, on-board inputs 491, off-board inputs 492 from other devices external to the host vehicle 400 and ECM battery power budgets and limits 493. The sensor data and parameters may include access secured device locations, mobile access device locations, host vehicle locations, occupant locations, occupant weights, occupant heart rates, host and other vehicle locations, vehicle speed, vehicle acceleration, battery state of charge, fuel level, etc. applications 486. The applications 486 may include applications executed by the modules 407, 408 and the ECMs 404. An ECM battery power budget and one or more limits may be stored for each of the ECMs 404. The ECM battery power budget and one or more limits may be for a set period of time. If the ECM battery power budget is utilized in the set period of time, then functionality of that ECM may be limited or stopped until reallocation of additional power for the ECM and/or assignment of a new ECM battery power budget for the ECM.

Although the memory 480 and the vehicle control module are shown as separate devices, the memory 480 and the vehicle control module may be implemented as a single device. The memory 480 may also store historical data 490 and other data such as driver driving patterns, driver fueling patterns, driver stopping patterns, typical work schedule, typical travel schedule, upcoming events, other driver patterns, data collected by and/or generated by at least one of the modules 407, 408 and ECMs 404, traffic data, navigation data, map data, GPS/GNSS data, path data, speed data, and acceleration data, etc.

The vehicle control module may control operation of the propulsion system 410, the video system including the display 420, 421, the audio system 422, the haptic devices, the brake system 476, the steering system 478, a seating system 496, and/or other devices and systems according to parameters set by the modules 407, 408 and ECMs 404. The seating system 496 may include seat sensors 497 for detecting presence of an occupant and/or change in occupants, for example, change in a driver. The vehicle control module may set at least some of the parameters based on signals received from the sensors 450.

The vehicle control module may receive power from the power sources 409, which may be provided to the propulsion system 410, the brake system 476, the steering system 478, the seating system 496, etc. Power supplied to the haptic devices, the motors 432, the brake system 476, the steering system 478, the seating system 496, and/or actuators thereof may be controlled by the vehicle control module to, for example, adjust: motor speed, torque, and/or acceleration; braking pressure; steering wheel angle; pedal position; state of haptic devices; etc. This control may be based on the outputs of the sensors 450, the navigation module 414, the GPS and GNSS receiver 416, the data and information received from external devices, and the data and information stored in the memory 480.

The vehicle control module 406 may determine various parameters including a vehicle speed, a motor speed, a gear state, an accelerator position, a brake pedal position, an amount of regenerative (charge) power, an amount of auto start/stop discharge power, and/or other information. The vehicle control module may control operations of the systems 410, 476, 478 based on the stated parameters. The vehicle control module may display vehicle status information based on the stated parameters.

The host vehicle 400 can include various systems for assisting a driver, for performing autonomous operations, and/or for indicating to a vehicle occupant information regarding an environment of the host vehicle. For example, a host system may include a navigation system that provides map information indicating lane boundaries, street locations, speed limits, geographical locations of selected destinations, etc. The host system may provide the driver with instructions for driving to a selected destination and/or may perform autonomous operations such as braking, steering, and accelerating operations to drive the vehicle to the destination based on the map information.

As another example, the host vehicle 400 may include object detection and collision warning systems for detecting impending objects and performing countermeasures and/or taking evasive action to prevent a collision. The vehicle control module determines locations of the objects relative to the host vehicle 400 and trajectories of the objects and the host vehicle 400. If it is determined that the host vehicle 400 is likely to collide with one of the objects, one or more warning signals may be generated to indicate to the driver and/or the object of concern of the potential collision. These warnings may be provided in addition to digital gateways and other information described herein. The vehicle control module 406 may also or alternatively perform one or more other countermeasures (e.g., apply brakes to decelerate the host vehicle, change a steering angle of the host vehicle, etc.) to prevent a collision.

FIG. 5 shows a commissioning method implemented by an external (or non-vehicular) IoT controller (or first NAD) for determining whether to add another IoT device and/or controller to in-vehicle subnetwork ecosystem and allocate resources of in-vehicle subnetwork ecosystem for the another IoT device and/or controller.

At 500, the first NAD (external IoT controller) of the vehicle receives requests from IoT compatible devices and/or controllers. The IoT compatible devices and/or controllers may be separate from the vehicle and be physically located externally, remotely, or internally to the vehicle. In an embodiment, each nearby matter (or IoT) compatible device and/or controller advertises intention to join vehicle IoT matter subnetwork. Although the operations of FIG. 5 are primarily described with respect to the first NAD, which is implemented in the vehicle, an IoT controller external to the vehicle that is part of the IoT ecosystem of the vehicle may perform the operations of FIG. 5 that are described as being performed by the first NAD.

At 502, the first NAD requests parameters of the IoT compatible devices and/or controllers. At 504, the first NAD receives capability information from each of the IoT compatible devices. This information may include computing capacity of the IoT compatible devices and/or controllers, computational needs, etc.

At 506, the first NAD, at each instance in time (or step of operation), obtains and/or updates its matrix of its subnetwork. The matrix may identify capabilities, power usage, functions performed, parameters provided by, states, etc. of IoT devices and other devices that are in the in-vehicle subnetwork ecosystem.

At 508, the first NAD determines whether usage capacity of the first NAD and/or vehicle are less than a minimum threshold. This is an indication of whether the first NAD (or external IoT controller) of the vehicle and/or vehicle is underutilized and has capacity to manage, control, and allocate resources to one or more of the IoT devices and/or controllers of the ecosystem. This includes allocation of services and power. This may be based on the parameters and/or usage capabilities of the IoT devices and/or controllers. If yes, operation 510 is performed, otherwise operation 512 is performed. If no, the first NAD and/or vehicle has no availability to lend (or provide) services and/or power to other IoT controllers and/or devices internal and/or external to the vehicle.

At 510, the first NAD advertises intention to lend and become common rooted external IoT controller for multiple subnetworks including at least one vehicle internal subnetwork. The at least one vehicle internal subnetwork may include the one or more IoT devices being added. In an embodiment, the first NAD load balances for an IoT controller that is external to the vehicle such as a home hub (or home IoT controller). If the first NAD is underutilized, it can become a lender to other IoT controllers in the ecosystem, which may be located in or external to the vehicle. The first NAD can lend services to additional devices or device sets in the ecosystem based on capabilities of the first NAD. The first NAD can distribute services and power to other devices (e.g., ECUs, BYODs, and/or IoT devices) in the ecosystem that are internal to or external to the vehicle. In an embodiment, the first NAD advertises that the vehicle can help perform services and/or distribute power.

At 512, the first NAD keeps Matter (IoT) status active and dynamically monitors availability of multi-IoT controller interface between the first NAD and a second NAD (or internal IoT controller) of the vehicle. This availability is based on the usage capacity of the first NAD. If not underutilized, the first NAD keeps monitoring an active state of IoT controllers internal and external to the vehicle that are part of the ecosystem.

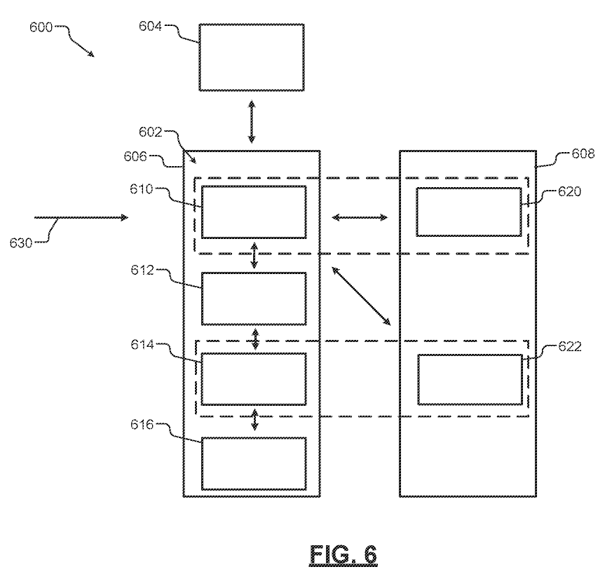

FIG. 6 shows a portion 600 of an IoT ecosystem including a portion 602 of an in-vehicle IoT subnetwork ecosystem. The portion 600 includes a portable device 604, a vehicle 606 and a building 608. The portion 602 includes an external IoT controller (or first NAD) 610, an internal IoT controller 612 (or second NAD), an infotainment system 614 and vehicle cameras 616. The building 608 includes a thermostat 620 and building cameras 622. Some example fabrics A, B are shown, the in-vehicle IoT subnetwork ecosystem may have other associated fabrics. A fabric incorporates electronic devices external and separate from the vehicle 606 into a system of the vehicle 606. A fabric may implement a group of features within an ecosystem. The vehicle 606 uses the external and separate devices to perform certain functions. In the example shown, fabric A includes the building cameras 622, which may be used by the infotainment system 614 to monitor internal and external views of the building. The views may be displayed on a display of the vehicle 606. Fabric B includes the thermostat 620, which may be used by the external IoT controller 610 to monitor and adjust a temperature within the building 608. The thermostat 620 may also or alternatively be utilized by the infotainment system 614. Another ecosystem that may be implemented within the vehicle may include BYODs, which may be provided access to the infotainment system 614 via the controllers 610, 612.

A single root certificate may be used by the thermostat 620 and the building cameras 622 when connecting to the vehicle 606. When be connected and authenticated, the thermostat 620 and the building cameras 622 may provide the root certificate to the external IoT controller 610, which verifies that the thermostat 620 and the building cameras 622 are authorized and trustworthy devices prior to permitting transfer of data between i) the external IoT controller 610 and ii) thermostat 620 and the building cameras 622. Another fabric may exist and include the portable device 604 (e.g., a mobile phone, a tablet, a smart wearable device such as a smart watch, etc.). The thermostat 620 and the building cameras 622 are considered part of the in-vehicle IoT subnetwork ecosystem and thus can share the same root certificate. Other fabrics may also exist such as one including BYODs.

Devices of the vehicle 606 may also be used as part of fabrics of the portable device 604 and/or the building 608. For example, an IoT controller of the portable device 604 and/or a IoT controller (or hub) of the building 608 may have fabrics that include devices such as the vehicle cameras 616, memory of the vehicle 606, a horn of the vehicle, a heater (seat or steering wheel heater), an air-conditioner of the vehicle, etc. The IoT controllers of the portable device 604 and the building 608 may control operation of the devices by communication with the external IoT controller 610. The external IoT controller may then provide requests to the internal IoT controller, which may then control or signal ECMs configured to control these devices.

Requests N1, N2 and/or other requests may be received at the external IoT controller 610. Request N1 may be associated with fabric A and request N2 may be associated with fabric B. Instead of requiring each request to have a unique root certificate, the requests N1 and N2 may have the same root certificate. The root certificate is common to multi-cluster devices controlled at the vehicle 606. This eliminates the need to renegotiate a root certificate for each feature being performed. The requests N1 and N2 may be received from, for example, a non-vehicular device separate from the vehicle 606 such as an IoT controller outside of the vehicle, a BYOD inside the vehicle, the portable device 604, the building 608, etc.

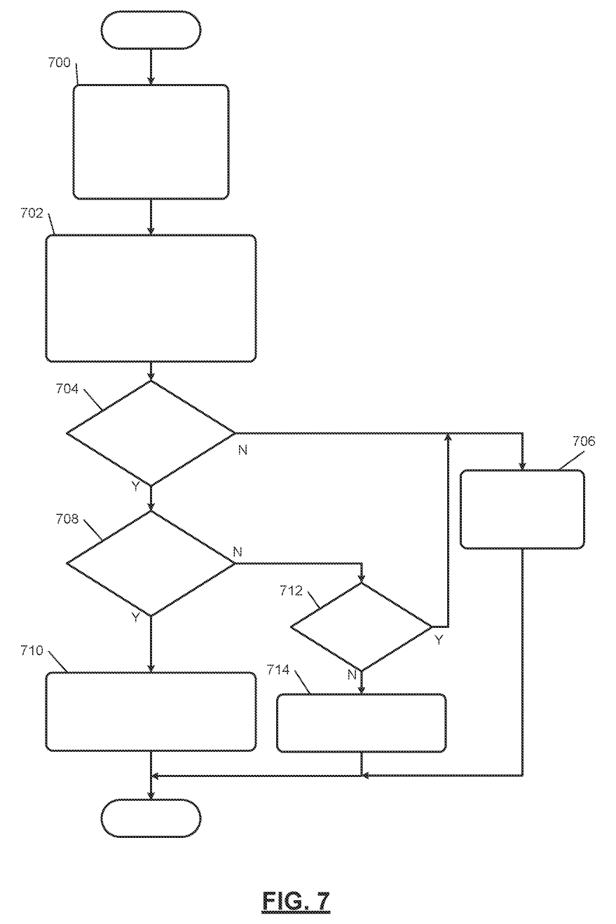

FIG. 7 shows a security method implemented by implemented by an external (or non-vehicular) IoT controller (or first NAD) including determine whether to treat an external (non-vehicular) IoT device and/or controller as an internal IoT device.

At 700, the first NAD accepts the external IoT device as part of the in-vehicle subnetwork ecosystem.

At 702, the first NAD determines a device classification of the external IoT device and/or controller based on information received such as capacity, energy usage, time(s) of resource availability for the external IoT device and/or controller, amount of time in the in-vehicle subnetwork ecosystem, etc. the classification may be external, internal, or other.

At 704, the first NAD determines whether the classification of the first NAD is external, internal, or other. If the classification is not external or internal, then operation 706 may be performed. Otherwise, operation 708 may be performed.

At 706, the first NAD updates information in a matrix for the external IoT device and/or controller. This update may include an indication that the external IoT device and/or controller is permitted to receive data from the vehicle but is not permitted to send data to the vehicle.

In an embodiment, when the classification is not external or internal, then a unique root certificate may be required for the external IoT device and/or controller. This is different then when the first NAD identifies the external IoT device and/or controller as an external IoT device or an internal IoT device of the in-vehicle IoT subnetwork ecosystem. In which case, a same root certificate that is common for one or more other IoT devices in the in-vehicle IoT subnetwork ecosystem is used. These operations eliminate the need for IoT devices and/or controllers to have to negotiate a new root certificate each time they connect up with the vehicle. This allows IoT devices (e.g., a vehicle charger) manufactured by a same manufacturer of the vehicle, BYODs, and/or other IoT devices previously verified to quickly connect to the vehicle and be treated as vehicular devices within the vehicle (or devices that are part of, built into, and/or manufactured as part of the vehicle).

At 708, the first NAD determines whether to an assign resource availability flag is True. When True, resource can be assigned to the external IoT device and/or controller. If True, operation 710 may be performed. Otherwise, operation 712 may be performed.

At 710, the first NAD runs a prioritization matrix process and assigns resource load(s) for the external IoT device and/or controller.

At 712, the first NAD determines whether resources are needed. If yes, operation 706 may be performed, otherwise operation 714 may be performed.

At 714, the first NAD marks external IoT device and/or controller as idle in the matrix. Subsequent to operation 714, the method may end as shown, or may return to operation 708.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. An in-vehicle Internet of things (IoT) subnetwork comprising:
a first network access device (NAD) configured to communicate with and receive first requests from IoT devices and controllers external to a host vehicle;
a plurality of electronic control modules (ECMs) configured to control a plurality of systems and devices within the host vehicle; and
a second NAD isolating the first NAD from the ECMs and configured to receive second requests from the first NAD based on the first requests and allocate selected ones of the ECMs to perform operations to address the second requests.

2. The IoT subnetwork of claim 1, wherein the second NAD is configured to communicate with a cloud-based network device to share vehicular information with the cloud-based network device; and
wherein the cloud-based network device is a server of a manufacturer of the host vehicle, a roadside unit, a traffic or map server, or a weather server.

3. The IoT subnetwork of claim 1, wherein at least one of: i) the first NAD maintains a same root certificate for the plurality of IoT controllers that are external to the host vehicle, and ii) the first NAD and the second NAD share a same root certificate.

4. The IoT subnetwork of claim 1, further comprising a plurality of internal IoT controllers, wherein:
the first NAD is configured to perform resource loading including prioritizing functions and to be performed and assign the functions to a selected one or more of the plurality of internal IoT controllers; and
the second NAD is implemented as one of the plurality of internal IoT controllers.

5. The IoT subnetwork of claim 1, wherein the second NAD is configured to perform resource loading and prioritize functions performed by the plurality of ECMs and assign selected ones of the ECMs to perform the functions.

6. The IoT subnetwork of claim 1, wherein the first NAD is configured to assign a same device type to the plurality of IoT controllers that are external to the host vehicle.

7. The IoT subnetwork of claim 1, wherein an interface between the first NAD and the second NAD is configured for transferring signals for concurrently handling at least one of i) requests from a plurality of IoT devices and ii) controlling the plurality of IoT devices.

8. The IoT subnetwork of claim 1, wherein the first NAD is configured to:
receive parameters and capability information from one of the plurality of IoT devices and controllers that are external to the host vehicle;
update a matrix based on the parameters and capability information received;
determine whether usage capacity of the first NAD is less than a minimum threshold;
based on the capability information and in response to the usage capacity being greater than or equal to the minimum threshold, maintain status of the one of the plurality of IoT devices and controllers as active and monitor availability of multi-IoT controller interface between the first NAD and the second NAD based on the usage capacity; and
based on the capability information and in response to the usage capacity being less than the minimum threshold, advertise intention of first NAD to lend and become a common rooted external IoT controller for multiple subnetworks.

9. The IoT subnetwork of claim 1, wherein the first NAD is configured to:
determine classification of an IoT device or controller that is at least one of external to and separate from the host vehicle;
in response to the classification being external or internal, determine whether to allocate resources to the IoT device or controller having the classification; and
in response to the classification not being external or internal, update an entry in a matrix for the IoT device or controller indicating that the IoT device or controller is permitted to receive not transmit.

10. The IoT subnetwork of claim 9, wherein the first NAD is configured to:
in response to determining to allocate resources to the IoT device or controller having the classification, run a prioritization matrix process and at least one of i) assign a resource load of the host vehicle to the IoT device or controller, and ii) assign a request for the IoT device or controller to the second NAD; and
in response to determining not to allocate resources to the IoT device or controller having the classification, determine whether resources are needed for the IoT device or controller and in response to resources not being needed, mark in the matrix that the IoT device or controller as being in an idle state.

11. A method of operating an in-vehicle Internet of things (IoT) subnetwork, the method comprising:
communicating with and receiving first requests at a first network access device (NAD) from IoT devices and controllers external to a host vehicle;
controlling a plurality of systems and devices within the host vehicle via a plurality of electronic control modules (ECMs);
isolating the first NAD from the ECMs via a second NAD; and
receiving second requests at the second NAD from the first NAD based on the first requests;
allocating via the second NAD selected ones of the ECMs to perform operations to address the second requests.

12. The method of claim 11, further comprising via the second NAD communicating with a cloud-based network device to share vehicular information with the cloud-based network device,
wherein the cloud-based network device is a server of a manufacturer of the host vehicle, a roadside unit, a traffic or map server, or a weather server.

13. The method of claim 11, further comprising at least one of:
maintaining at the first NAD a same root certificate for the plurality of IoT controllers that are external to the host vehicle; and
sharing a same root certificate by the first NAD and the second NAD.

14. The method of claim 11, further comprising performing resource loading via the first NAD including prioritizing functions to be performed and assigning the functions to a selected one or more of a plurality of internal IoT controllers of the host vehicle,
wherein the second NAD is implemented as one of the plurality of internal IoT controllers.

15. The method of claim 11, further comprising, via the second NAD, performing resource loading and prioritizing functions performed by the plurality of ECMs and assigning selected ones of the ECMs to perform the functions.

16. The method of claim 11, further comprising, via the first NAD, assigning a same device type to the plurality of IoT controllers that are external to the host vehicle.

17. The method of claim 11, further comprising, via an interface between the first NAD and the second NAD, transferring signals for concurrently handling at least one of i) requests from a plurality of IoT devices and ii) controlling the plurality of IoT devices.

18. The method of claim 11, further comprising:
receiving parameters and capability information at the first NAD from one of the plurality of IoT devices and controllers that are external to the host vehicle;
updating a matrix based on the parameters and capability information received;
determining whether usage capacity of the first NAD is less than a minimum threshold;
based on the capability information and in response to the usage capacity being greater than or equal to the minimum threshold, maintaining status of the one of the plurality of IoT devices and controllers as active and monitoring availability of multi-IoT controller interface between the first NAD and the second NAD based on the usage capacity; and
based on the capability information and in response to the usage capacity being less than the minimum threshold, advertising intention of first NAD to lend and become a common rooted external IoT controller for multiple subnetworks.

19. The method of claim 11, further comprising:
determine, via the first NAD, classification of an IoT device or controller that is at least one of external to and separate from the host vehicle;
in response to the classification being external or internal, determine whether to allocate resources to the IoT device or controller having the classification; and
in response to the classification not being external or internal, update an entry in a matrix for the IoT device or controller indicating that the IoT device or controller is permitted to receive not transmit.

20. An in-vehicle Internet of things (IoT) subnetwork comprising:
a first IoT controller implemented in a host vehicle and configured to communicate with and receive first requests from IoT devices and controllers external to the host vehicle;
a plurality of electronic control modules (ECMs) configured to control a plurality of systems and devices within the host vehicle; and
a second IoT controller implemented in the host vehicle and isolating the first IoT controller from the ECMs and configured to receive second requests from the first IoT controller based on the first requests and allocate selected ones of the ECMs to perform operations to address the second requests.
